(19) United States
(12) Patent Application Publication
(10) Pub. No.: US 2010/0077130 A1
(43) Pub. Date: Mar. 25, 2010

(54) Multiprocessor system with booting function using memory link architecture

(75) Inventor: Jin-Hyoung Kwon, Seongnam-si (KR)

Correspondence Address: HARNESS, DICKEY & PIERCE, P.L.C., P.O. BOX 8910, RESTON, VA, 20195, US

(73) Assignee: SAMSUNG ELECTRONICS CO., LTD.

(21) Appl. No.: 12/461,183

(22) Filed: Aug. 4, 2009

(30) Foreign Application Priority Data
Sep. 24, 2008 (KR) 10-2008-0093533

(51) Int. Cl. G06F 9/00; G06F 12/02

(52) U.S. Cl. 711/102; 713/2; 711/E12.002

(57) ABSTRACT

The multiprocessor system includes first and second multiport semiconductor memory devices, first, second and third processors individually storing a first boot loader, the first and second processors being configured to access the first multiport semiconductor memory device, and the second and third processors being configured to access the second multiport semiconductor memory device, and a memory link architecture including the second multiport semiconductor memory device, the third processor, and a nonvolatile semiconductor memory device. The nonvolatile semiconductor memory device includes a plurality of storage areas storing a second boot loader and software for the first, second and third processors. The third processor is configured to access the nonvolatile semiconductor memory device and configured to apply the second boot loader to the first and second processors through a serial communication to perform a portion of booting the system.

### PRIORITY STATEMENT

This application claims priority under 35 U.S.C. §119 from Korean Patent Application 10-2008-0093533, filed on Sep. 24, 2008, the contents of which are hereby incorporated by reference in their entirety as if fully set forth herein.

### BACKGROUND

Example embodiments of the present invention relate to a multiprocessor system, for example, to a multiprocessor system having a booting function using a memory link architecture.

In recent mobile communication systems, i.e., multimedia electronic devices such as a portable multimedia player (PMP) or handheld phone (HHP), or personal digital assistant (PDA) unit etc., a multiprocessor system employs a plurality of processors within one system to achieve higher speeds and smoother operation in functions. For example, in mobile phones, besides a basic telephone function, functions such as, music, gaming, camera, payment, moving picture etc., may be additionally implemented. Thus, a communication processor and an application processor may both need to be adapted in a printed circuit board (PCB) of the mobile phone, with the communication processor performing a communication modulation/demodulation and the application processor performing an application function other than a communication function of the communication processor.

In such a multiprocessor system, a semiconductor memory employed to store processed-data may be changed in an operation or functional aspect. For example, a plurality of access ports may be employed, which may then simultaneously input/output data.

In general, a semiconductor memory device having two access ports is called a dual-port memory. A general dual-port memory is well known in the field and may be employed as an image processing video memory having a Random Access Memory (RAM) port accessible in a random sequence and a Sequential Access Memory (SAM) port accessible in a serial sequence. On the other hand, a Dynamic Random Access Memory (DRAM), which does not employ a SAM port and for which a shared memory area of a memory cell array including DRAM cells is accessible by respective processors through a plurality of access ports, is called herein a multiport semiconductor memory device or multipath accessible semiconductor memory device.

FIG. 1 illustrates a block diagram of a multiprocessor system 50 according to a related art. In FIG. 1, the multiprocessor system 50 includes a memory array 35 having first, second and third portions 33, 31 and 32. The first portion 33 of the memory array 35 is accessed only by a first processor 70 through a port 37, and the second portion 31 is accessed only by a second processor 80 through a port 38, and the third portion 32 is accessed by both of the first and second processors 70 and 80. The size of the first and second portions 33 and 31 in the memory array 35 may be flexibly changed depending on an operation load of the first and second processors 70 and 80. The memory array 35 is illustrated as being realized in a memory type or disk storage type.

To adapt the third portion 32 to be shared by the first and second processors 70 and 80 within the memory array 35 of a DRAM structure, several issues must be resolved. One of the issues is to appropriately control a read/write path for respective ports and a layout of memory areas within the memory array 35.

A boot memory, e.g., flash memory, for a booting of respective processors, is generally correspondingly coupled to every processor in a multiprocessor system employing a multiport semiconductor memory device, thus causing increased implementation expenses of the system and causing a increased complication in the size of the multiprocessor system 50.

Therefore, the related art is unable to provide a smoother booting operation without coupling a boot memory, such as flash memory, to each of the processors.

### SUMMARY

Accordingly, one or more example embodiments of the invention provide a multiprocessor system capable of performing a booting without a boot memory directly coupled to a processor. The booting may be performed even without directly coupling a boot flash memory with processors. The multiprocessor system has a booting function utilizing a memory link architecture. In a flashless structure that boot flash memories are not directly coupled with processors, the booting of processors may be performed more smoothly.

An example embodiment of the invention provides a multiprocessor system capable of reducing system implementation expenses and the size of system by removing flash memories directly coupled with processors for a booting of the processors.

According to an example embodiment, the multiprocessor system includes first and second multiport semiconductor memory devices, first, second and third processors individually storing a first boot loader, the first and second processors being configured to access the first multiport semiconductor memory device, and the second and third processors being configured to access the second multiport semiconductor memory device, and a memory link architecture including the second multiport semiconductor memory device, the third processor, and a nonvolatile semiconductor memory device, the nonvolatile semiconductor memory device including a plurality of storage areas storing a second boot loader and software for the first, second and third processors, and the third processor being configured to access the nonvolatile semiconductor memory device and configured to apply the second boot loader to the first and second processors through a serial communication to perform a portion of booting the system.

In an example embodiment, the third processor reads the software for the second processor and then provides the software for the second processor to the second processor through the second multiport semiconductor memory device.

In an example embodiment, the second multiport semiconductor memory device and the first multiport semiconductor memory device sequentially provide the software for the first processor to the first processor.

In an example embodiment, the third processor reads the software for the first processor and then provides the software for the first processor to the second processor through the second multiport semiconductor memory device, the second processor writes the software for the first processor to the first multiport semiconductor memory device, and the first multiport semiconductor memory device provides the software for the first processor to the first processor.

In an example embodiment, the first, second and third processors include a read only memory (ROM), the first boot loader being a program for an initialization of the first, second and third processors that is stored in the ROM of the first, second and third processors.

In an example embodiment, the second boot loader is a program to operate an operating system of the first, second and third processors.

In an example embodiment, the software for the first processor is modem software, and the software for the second processor is software of an operating system.

According to an example embodiment, the multiprocessor system includes a first multiport semiconductor memory device including a shared memory area assigned in a memory cell array and an internal register positioned outside the memory cell array, the internal register adapted to provide an access authority for the shared memory area, first and second processors individually having a storage memory and a reset terminal, the storage memory being configured to store a first boot loader, with the first and second processors configured to receive the access authority for the shared memory area through the internal register and configured to access in common the shared memory area through different ports of the first multiport semiconductor memory device, and a memory link architecture block including a third processor having a first boot loader storage memory, a second multiport semiconductor memory device, and a nonvolatile semiconductor memory device, the second multiport semiconductor memory device including a shared memory area assigned in a memory cell array and an internal register positioned outside the memory cell array, the second and third processors configured to access the shared memory area in common through different ports of the second multiport semiconductor memory device, and the internal register adapted to provide an access authority for the shared memory area to the second and third processors, the nonvolatile semiconductor memory device having a plurality of areas storing a second boot loader and software for the first, second and third processors, and the third processor configured to access the nonvolatile semiconductor memory device and configured to provide the second boot loader of the first and second processors stored in the nonvolatile semiconductor memory device to the first and second processors through a serial communication port in booting the system.

In an example embodiment, the third processor applies a reset signal to the reset terminal of the first and second processors to prevent a booting time out of the first and second processors.

According to an example embodiment, a memory link architecture block includes a first multiport semiconductor memory device including a shared memory area assigned in a memory cell array and a first port, a first processor storing a first boot loader, the first processor configured to access the shared memory area through the first port of the first multiport semiconductor memory device, and a nonvolatile semiconductor memory device having a plurality of areas storing a second boot loader and software for at least the first processor, the first processor being configured to access the nonvolatile semiconductor memory device.

In an example embodiment, the memory link architecture block is included in a multiprocessor system further including a second multiport semiconductor memory device, and second and third processors each storing the first boot loader, the second and third processors being configured to access the second multiport semiconductor memory device, and the second processor being further configured to access the shared memory area of the first multiport semiconductor memory through a second port of the first multiport semiconductor memory device, wherein the nonvolatile semiconductor memory device further stores the second boot loader and software for the second and third processors, and the first processor applies the second boot loader to the first and second processors through a serial communication to perform a portion of booting the system.

In an example embodiment, the nonvolatile semiconductor memory device may be a flash memory. The flash memory may be a NAND type flash memory having a memory cell structure of a NAND type.

In an example embodiment, the shared memory area may be assigned in a unit of memory bank. The memory cell array may further include dedicated-memory areas dedicatedly accessed by each of the processors.

In an example embodiment, the internal register may include semaphore areas with storage of access authority information, and mailbox areas storing a message for a request or change execution of the access authority.

In an example embodiment, the multiprocessor system may be one of mobile phone, PMP, PSP, PDA and vehicle-use portable phone. The nonvolatile memory may be a memory of EEPROM group, a flash memory or a PRAM (Phase-change RAM).

In a flashless structure that boot flash memories are not directly coupled with processors, a booting of processors may be performed more smoothly. Flash memories for a booting of processors are not adapted and thus implementation expenses of the system are reduced and the size of the system becomes more compact, relatively. A high-performance multiprocessor system based on a memory link architecture and a multiport semiconductor memory device is obtained in performing a booting in a flashless structure.

### BRIEF DESCRIPTION OF THE DRAWINGS

The above and other features and advantages will become more apparent by describing in detail example embodiments thereof with reference to the attached drawings in which:

FIG. 1 is a block diagram schematically illustrating a multiprocessor system according to a related art;

FIG. 2 is a block diagram schematically illustrating a memory connection structure of a multiprocessor system according to a related art;

FIG. 3 is a block diagram of multiprocessor system employing a multiport semiconductor memory device and a memory link architecture according to an example embodiment of the present invention;

FIG. 4 is a block diagram illustrating in more detail a multiport semiconductor memory device and a memory link architecture block of FIG. 3;

FIG. 5 is a block diagram illustrating in more detail a multi-port semiconductor memory device of FIG. 3;

FIG. 6 provides an address assignment and substitutive access relation of internal register and memory banks of FIG. 5;

FIG. 7 is a circuit diagram illustrating in more detail an example of multipath accessing to a shared memory area of FIG. 5;

FIG. 8 is a block diagram illustrating a coupling example between a first port unit and a first path unit of FIG. 5;

FIG. 9 is a block diagram of a nonvolatile semiconductor memory device of FIG. 3;

FIG. 10 illustrates a structure of unit memory cells constituting a memory cell array of FIG. 9;

FIG. 11 provides an example of a NAND-type memory cell array formed by disposing the unit memory cells of FIG. 10 in a string type; and

FIG. 12 illustrates a control flow of booting in a multiprocessor system according to an example embodiment of the present invention.

### DETAILED DESCRIPTION OF EXAMPLE EMBODIMENTS

Example Embodiments of the invention now will be described more fully hereinafter with reference to the accompanying drawings, in which example embodiments of the invention are shown. Example embodiments of the present invention may, however, be embodied in many different forms and should not be construed as limited to the example embodiments set forth herein. Rather example embodiments are provided so that this disclosure will be thorough and complete, and will fully convey the invention to those skilled in the art.

Example embodiments will now be described more fully with reference to the accompanying drawings. In the drawings, the thicknesses of layers and regions may be exaggerated for clarity.

Accordingly, while example embodiments are capable of various modifications and alternative forms, embodiments thereof are shown by way of example in the drawings and will herein be described in detail. It should be understood, however, that there is no intent to limit example embodiments to the particular forms disclosed, but on the contrary, example embodiments are to cover all modifications, equivalents, and alternatives falling within the scope of example embodiments. Like numbers refer to like elements throughout the description of the figures.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of example embodiments. As used herein, the term “and/or” includes any and all combinations of one or more of the associated listed items.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (e.g., “between” versus “directly between”, “adjacent” versus “directly adjacent”, etc.).

Spatially relative terms, such as “beneath,” “below,” “lower,” “above,” “upper,” and the like may be used herein for ease of description to describe the relationship of one component and/or feature to another component and/or feature, or other component(s) and/or feature(s), as illustrated in the drawings. It will be understood that the spatially relative terms are intended to encompass different orientations of the device in use or operation in addition to the orientation depicted in the figures. The figures are intended to depict example embodiments and should not be interpreted to limit the intended scope of the claims. The accompanying figures are not to be considered as drawn to scale unless explicitly noted.

The terminology used herein is for the purpose of describing particular embodiments only and is not intended to be limiting of example embodiments. As used herein, the singular forms “a”, “an” and “the” are intended to include the plural forms as well, unless the context clearly indicates otherwise. It will be further understood that the terms “comprises”, “comprising,”, “includes” and/or “including”, when used herein, specify the presence of stated features, integers, steps, operations, elements, and/or components, but do not preclude the presence or addition of one or more other features, integers, steps, operations, elements, components, and/or groups thereof. In this specification, the term “and/or” picks out each individual item as well as all combinations of them.

Example embodiments of the present invention are described herein with reference to cross-section illustrations that are schematic illustrations of idealized embodiments (and intermediate structures) of the invention. As such, variations from the shapes of the illustrations as a result, for example, of manufacturing techniques and/or tolerances, are to be expected. Thus, embodiments of the present invention should not be construed as limited to the particular shapes of regions illustrated herein but are to include deviations in shapes that result, for example, from manufacturing. For example, an implanted region illustrated as a rectangle will, typically, have rounded or curved features and/or a gradient of implant concentration at its edges rather than a binary change from implanted to non-implanted region. Likewise, a buried region formed by implantation may result in some implantation in the region between the buried region and the surface through which the implantation takes place. Thus, the regions illustrated in the figures are schematic in nature and their shapes are not intended to illustrate the actual shape of a region of a device and are not intended to limit the scope of the present invention.

Unless otherwise defined, all terms (including technical and scientific terms) used herein have the same meaning as commonly understood by one of ordinary skill in the art to which example embodiments belongs. It will be further understood that terms, such as those defined in commonly used dictionaries, should be interpreted as having a meaning that is consistent with their meaning in the context of the relevant art and should not be interpreted in an idealized or overly formal sense unless expressly so defined herein.

It should also be noted that in some alternative implementations, the functions/acts noted may occur out of the order noted in the FIGS. For example, two FIGS. shown in succession may in fact be executed substantially concurrently or may sometimes be executed in the reverse order, depending upon the functionality/acts involved.

Now, in order to more specifically describe example embodiments, example embodiments will be described in detail with reference to the attached drawings. However, example embodiments are not limited to the embodiments described herein, but may be embodied in various forms. In the figures, if a layer is formed on another layer or a substrate, it means that the layer is directly formed on another layer or a substrate, or that a third layer is interposed there between.

When it is determined that a detailed description related to a related known function or configuration may make the purpose of example embodiments unnecessarily ambiguous, the detailed description thereof will be omitted. Also, terms used herein are defined to appropriately describe example embodiments and thus may be changed depending on a user, the intent of an operator, or a custom. Accordingly, the terms must be defined based on the following overall description within this specification.

A multiprocessor system having a booting function using a memory link architecture is described as follows, referring to the accompanying drawings according to example embodiments of the invention. For clarity, a detailed description for other examples, publication methods, procedures, general dynamic random access memories or flash memories and its related functional circuits has been omitted.

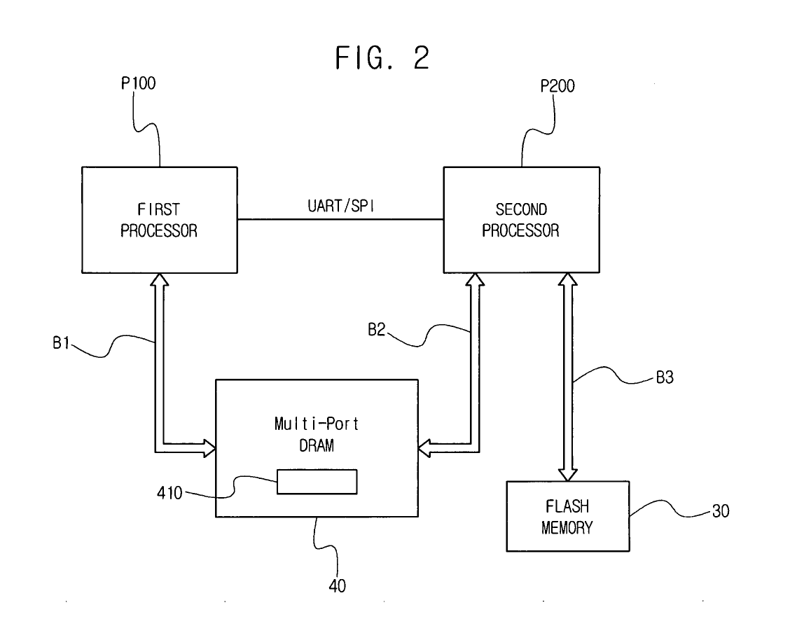

FIG. 2 is a block diagram schematically illustrating a memory connection structure of a multiprocessor system according to a related art, in a system structure including first and second processors P100 and P200, a multi-port DRAM 40 and a flash memory 30.

The multiprocessor system in FIG. 2 may be adaptable to a mobile communication device, e.g., handheld phones. First and second processors P100 and P200 employed in the multiprocessor system share the DRAM 40, which includes a plurality of ports. The first processor P100 is coupled to the DRAM 40 through a first system bus B1 and the second processor is coupled to the DRAM 40 through a second system bus B2. The first and second processor P100 and P200 are also coupled to each other through a host interface, e.g., UART/SPI interface etc. The flash memory 30 is coupled to the second processor P200 through a bus line B3. Thus, the first processor P100 may indirectly access the flash memory 30 through the DRAM 40 and/or the second processor P200. On the other hand, the second processor P200 directly accesses the flash memory 30.

The first processor P100 may have a function of a MODEM processor performing a task, e.g., modulation and demodulation of a communication signal, and the second processor P200 may have an application processor function of performing a user convenience function, e.g., processing of communication data or games, etc., or vice versa. The first and second processors P100 and P200 may also perform other or additional functions in other cases as well.

The flash memory 30 may be a NOR flash memory having a NOR structure in a cell array or a NAND flash memory having a NAND structure in a cell array. The NOR flash memory and NAND flash memory are both nonvolatile memories having memory cells in an array type, the memory cells including MOS transistors having a floating gate. Such a NOR flash memory or a NAND flash memory are adapted to store data that is not deleted even when the power is turned off, e.g., boot codes of portable devices, programs, communication data, or preservation data.

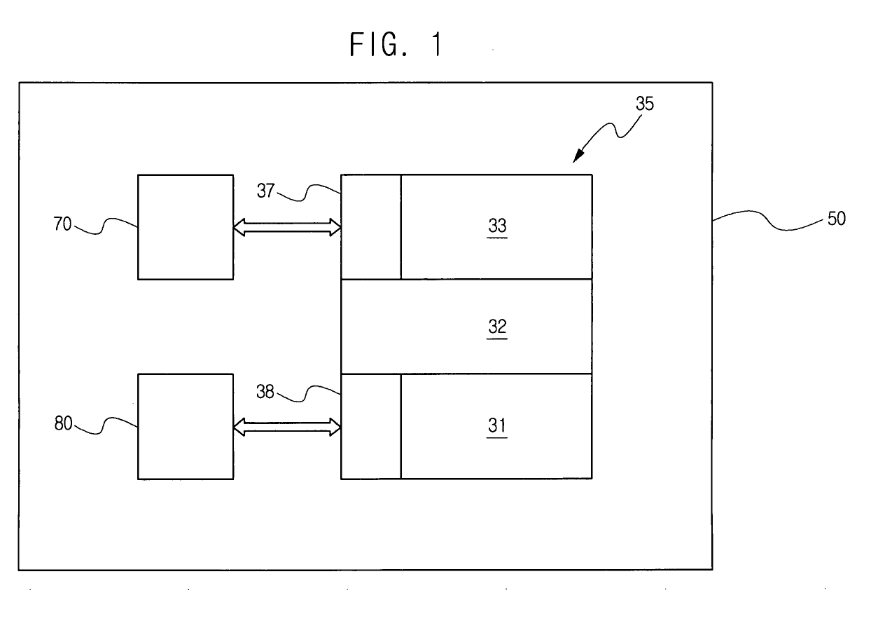

The multiport DRAM 40 functions as a main memory for processing data of processors P100 and P200. As illustrated in FIG. 2, the multiport DRAM 40 may be accessed through the first system bus B1 by the first processor P100 and through the second system bus B2 by the second processor P200. The multiport DRAM 40 includes therein memory banks and ports individually coupled corresponding to the first and second system buses B1 and B2. For example, the memory banks may have a structure similar to that of the memory array 35 in the multiprocessor system 50 of FIG. 1. Such a structure is different from a general DRAM, which has a single port.

The multiport DRAM 40 is a fusion memory chip capable of increasing a data processing speed between a communication processor and a media processor in a mobile device. Generally, two processors require two memories. However, the multiport DRAM 40 is able to route data between two processors through a single chip, thus the need for two memories may be removed. The multiport DRAM 40 may reduce time taken in transmitting data between processors by employing a dual-port approach. The multiport DRAM 40 may substitute for at least two mobile memory chips within a high-performance smart-phone and other multimedia rich-handset. As a data processing speed between processors increases, the multiport DRAM 40 may reduce power consumption by, for example, approximately 30 percent more. Further, multiport DRAM 40 may reduce the total number of chips needed so that overall die area coverage may be reduced by approximately 50 percent. As a result, the speed of cellular phones may increase, for example, by approximately five times and battery life may be prolonged. Further, a design of the cellular phone may become slimmer.

For example, the multiport DRAM 40 of FIG. 2 may have a memory cell array including four memory banks. A first bank may be accessed dedicatedly by the first processor P100, and third and fourth banks may be accessed dedicatedly by second processor P200. A second bank may be accessed by both of the first and second processors P100 and P200 through different ports. As a result, in the memory cell array, the second bank may be assigned as a shared memory area, and the first, third and fourth banks may be assigned as the dedicated memory areas accessed only by one of the corresponding first and second processors P100 and P200.

When the first processor P100 accesses the second bank, a path controller 410 of the multiport DRAM 40 controls access so that the second bank is coupled to a system bus B1. While the first processor P100 accesses the second bank, the second processor P200 may access the third or fourth bank as the dedicated memory. When the first processor P100 does not access the second bank, the second processor P200 can access the second bank as the shared memory area.

In the memory connection structure of FIG. 2, the first processor P100 can not directly access the flash memory 30. If another flash memory was coupled to the first processor P100, then the first processor would have direct access to the flash memory, but this would not be effective in simplifying the entire system and reducing cost. Accordingly, the first processor P100 communicates with the second processor P200 through the host interface, e.g., the UART/SPI interface etc., and thus reads data stored in the flash memory 30 or writes data to the flash memory 30 through the multi-port DRAM 40 or the second processor P200.

However, in employing a memory link architecture block in a multiprocessor system, the first processor P100 and the booting flash memory 30 are directly coupled to other processors, such the second processor P200. A flash memory, such the flash memory 30, is also needed within the memory link architecture block. Thus, a plurality of flash memories are employed in one multiprocessor system, and a realized cost of the system becomes relatively high and a size of system becomes relatively complicated.

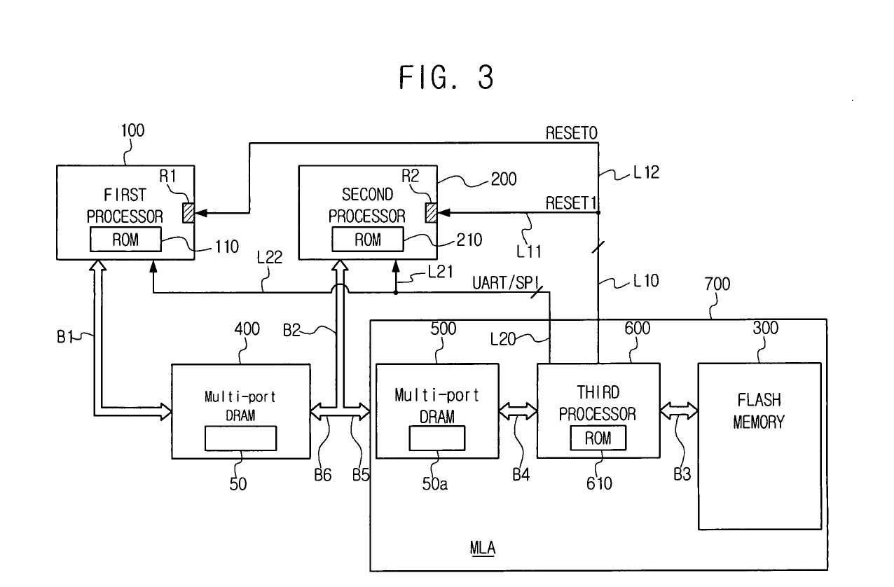

According to an example embodiment of the invention, an example of multiprocessor system capable of more smoothly performing the booting of processors, even in a flashless structure where booting flash memories are not directly coupled to processors, is provided in FIG. 3.

FIG. 3 is a block diagram of multiprocessor system employing a multiport semiconductor memory device and a memory link architecture according to an example embodiment of the present invention. In FIG. 3, a boot memory is not directly coupled to either of the respective processors 100 and 200 in a multiprocessor system employing the DRAM 400 and a memory link architecture 700, thus a cost of system is relatively low and the size of system becomes more compact.

FIG. 3 illustrates a block diagram of a multiprocessor system employing a multiport semiconductor memory device and a memory link architecture according to an example embodiment of the invention. Unlike the connection of FIG. 2, the nonvolatile semiconductor memory device, e.g., flash memory 300, in FIG. 3 is not directly coupled to the second processor 200. For example, neither of the first and second processors 100 and 200 is not directly coupled to the flash memory 300. Thus, the multiprocessor system of FIG. 3 has a flashless structure.

In FIG. 3, the first and second processors 100 and 200 individually have ROM memories 110 and 210 as a first boot loader storage memory and reset terminals R1 and R2.

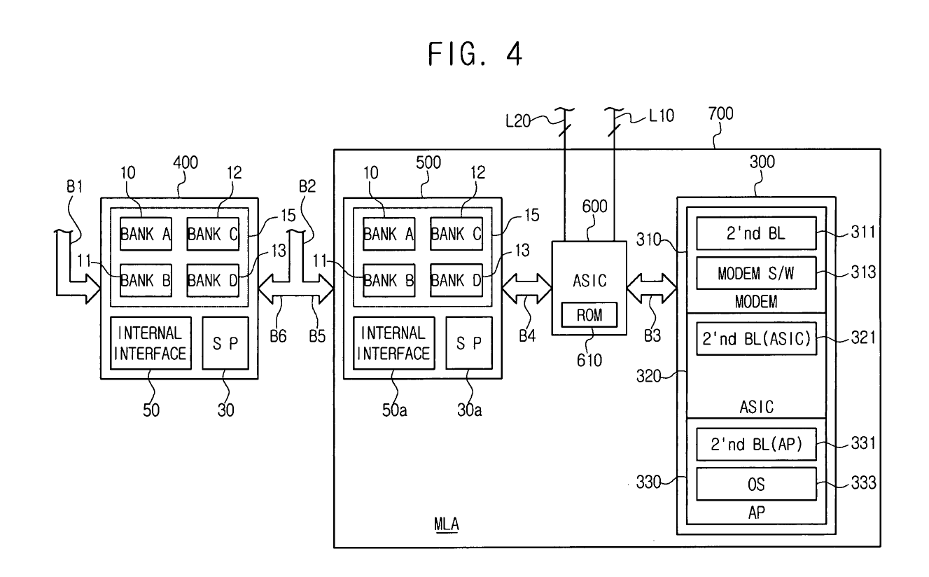

A first multi-port DRAM 400 includes a shared memory area 11 referred to in FIG. 4, accessed in common by the first and second processors 100 and 200 through different ports and assigned within a memory cell array, and an internal register 50 positioned outside the memory cell array, the internal register 50 being adapted to provide an access authority for the shared memory area to the first and second processors 100 and 200.

The memory link architecture block 700 includes a third processor 600 having a first boot loader storage memory 610; a link multiport semiconductor memory device, e.g. a second multi-port DRAM 500 including a shared memory area accessed in common by the second and third processors 200 and 600 through different ports and assigned within a memory cell array, and an internal register 50a positioned outside the memory cell array, the internal register 50a being adapted to provide an access authority for the shared memory area to the second and third processors; and a nonvolatile semiconductor memory device 300 including areas storing a second boot loader and software for the first, second and third processors 100, 200 and 600 and being accessed by the third processor 600.

In the flashless structure of FIG. 3, a portion of system booting may be obtained as the third processor 600 provides the second boot loader of the first and second processors 100 and 200 stored in the nonvolatile semiconductor memory device, e.g., the flash memory 300, through a serial communication port, e.g., UART or SPI.

When a power source is applied to the multiprocessor system, the booting of system starts. The first, second and third processors 100, 200 and 600 read the first boot loader from their respective own ROM memories 110, 210 and 610.

Subsequently, the third processor 600 applies respective reset signals RESET0 and RESET1 to the first and second processors 100 and 200 through lines L10, L11, and L12 to prevent a booting time out of the processors 100 and 200, and reads the second boot loader by accessing the flash memory 300 and then sets a port of the second DRAM 500.

The third processor 600 releases the reset of the second processor 200, and then transmits the second boot loader of the second processor 200 stored in the flash memory 300 to the second processor 200 through the UART/SPI line L21. The second processor 200 receives the second boot loader and sets a port of the second DRAM 500.

The third processor 600 reads software, e.g., an operating system (OS), of the second processor 200 stored in the flash memory 300 and writes it to the second DRAM 500. Then, the second processor 200 completes its own booting operation by reading the OS written to the second DRAM 500.

When the booting for the second processor 200 is completed, the third processor 600 releases the reset of the first processor 100.

The third processor 600 transmits the second boot loader of the first processor 100 stored in the flash memory 300 to the first processor 100 through the UART/SP1 line L22. The first processor 100 receives the transmitted second boot loader and sets a port of the first DRAM 400 not included in the memory link architecture block 700.

The third processor 600 reads software, e.g., MODEM software, of the first processor 100 stored in the flash memory 300, and writes it to the second DRAM 500 of the memory link architecture block 700. Thus, the second processor 200 reads the software written to the second DRAM 500 and writes it to the first DRAM 400. The first processor 100 completes its own booting operation by reading the software written to the first DRAM 400.

The system booting operation of the multiprocessor system is completed through the operations described above.

In FIG. 3, the first boot loader is a program to initialize a processor and is stored in each of read only memories (ROM) individually mounted inside the first, second and third processors 100, 200 and 600, and the second boot loader is a program to operate the OS of the first, second and third processors 100, 200 and 600 and is stored in the flash memory 300. The first boot loader may be a program, e.g., master boot recorder (MBR) etc., and the second boot loader may be a program, e.g., NT Loader (NTLDR) or grand unified boot loader (GRUB) to operate the OS of the first, second and third processors 100, 200 and 600.

The first boot loader may be written in an assembly language, and the first, second and third processors 100, 200 and 600 may perform an initialization at a low level necessary for operation of the first, second and third processors 100, 200 and 600 by reading the first boot loader. A register of a memory controller is determined by the initialization execution, and a speed of a system clock is determined, and the UART is initialized.

The second boot loader may be written in a C language, and is required to perform an initialization at a high level on the basis of the initialization environment of the low level. For example, the second boot loader may correspond to a program operating the OS. After the second boot loader transfers a control authority to the OS, a role of the second boot loader is no longer required.

FIG. 4 is a block diagram illustrating in more detail the multiport semiconductor memory device and the memory link architecture block of FIG. 3.

With reference to FIG. 4 there is shown in detail a structure of the first and second DRAMs 400 and 500, the third processor 600 and the flash memory 300.

In FIG. 4, each multiport semiconductor memory device, e.g., the first DRAM 400, may be coupled to two processors through different system buses and may include four memory banks constituting a memory cell array. A bank A 10 functioning as a first dedicated memory area may be configured to be accessed dedicatedly by the first processor 100, and banks C and D, 12 and 13, functioning as second dedicated memory areas may be configured to be accessed dedicatedly by second processor 200. On the other hand, bank B 11 as the shared memory area has a connection structure being accessed by both of the first and second processors 100 and 200. Thus, the bank B11 within the memory cell array is assigned as the shared memory area.

The dedicated memory areas 10, 12 and 13 and the shared memory area 11 may be all include DRAM cells, where each of the DRAM cells includes one access transistor and one storage capacitor. The DRAM cells have a refresh operation to preserve a storage charge of cell.

The four memory areas 10, 11, 12 and 13 may be individually configured as a bank unit. One bank may have a memory storage of, for example, 16 Mb (Megabit), 32 Mb, 64 Mb, 128 Mb, 256 Mb, 512 Mb, 1024 Mb, etc.

Internal interface 50 of the first DRAM 400 may be realized as the internal register and function as a path controller. The internal register 50 controls a switching unit SP 30, such that the second bank 11 is coupled to the system bus B1 when the first processor 100 accesses the second bank 11, and the second bank 11 is coupled to the system bus B2 when the second processor 200 accesses the second bank 11.

The second DRAM 500 adapted within the memory link architecture (MLA) block 700 may also have the same internal structure as the first DRAM 400.

The application-specific integrated circuit (ASIC) 600 functions as the third processor 600.

In the MLA block 700 of FIG. 4, the flash memory 300 includes a MODEM storage area 310, an ASIC storage area 320 and an application processor (AP) storage area 330. A second boot loader area 311 and a MODEM software area 313 for the first processor 100 are arranged in the MODEM storage area 310. A second boot loader area 321 for the third processor 600 is arranged in the ASIC storage area 320. A second boot loader area 331 and an OS area 333 for the second processor 200 are arranged in the AP storage area 330.

The first and second processors 100 and 200 have a flashless structure of being not directly coupled to the flash memory 300. Thus, the third processor 600 is used in the system booting. The third processor 600 coupled to the second DRAM 500 through a fourth system bus B4 and coupled to the flash memory 300 through a third system bus B3 communicates with the first and second processors 100 and 200 through a serial communication line L20, and communicates with the second processor 200 through the second DRAM 500. On the other hand, the second processor 200 communicates with the first processor through the first DRAM 400.

The system booting of the multiprocessor system in the flashless structure is performing by using the MLA through the communication scheme described above.

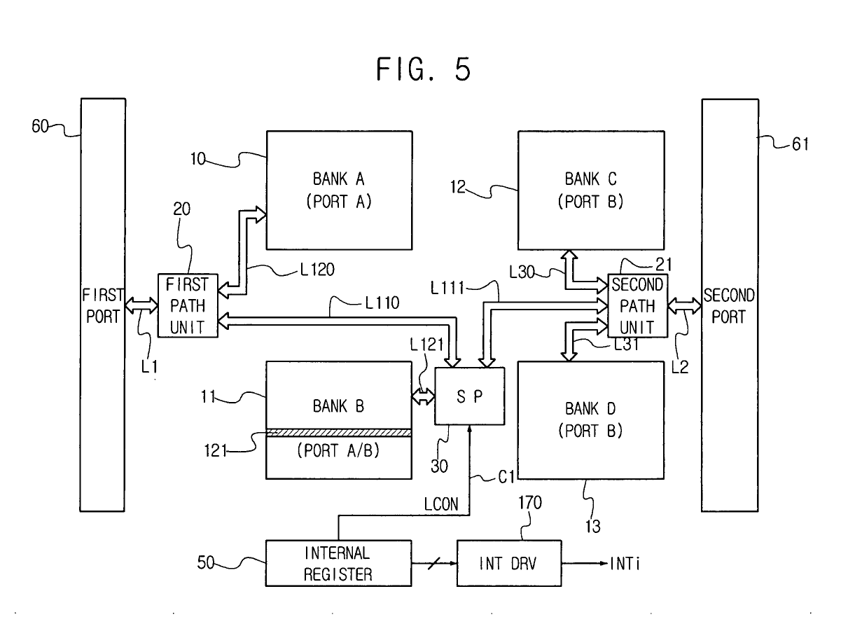

FIG. 5 is a block diagram illustrating in more detail the multiport semiconductor memory device of FIG. 3. For example, the multiport semiconductor memory device shown in FIG. 5 may illustrate the first DRAM 400.

First and second ports 60 and 61 shown in FIG. 5 constitute port units. The port units are respectively coupled to the first and second processors 100 and 200.

The shared memory area 11 as the bank B is accessed in common by the first and second processors 100 and 200 through the port units and is assigned with a portion of the memory capacity of the memory cell array.

The internal register 50 functioning as a path control unit controls a data path between the shared memory area 11 and the port units 60 and 61 through a switching unit SP 30, to get a data transmission/reception between the processors 100 and 200 through the shared memory area 11. When a specific address accessing a specific area 121 of the shared memory area 11 is applied, the internal register 50 is accessed instead of the specific area of the shared memory area 11 outside the memory cell array.

The switching unit SP 30 is coupled to the internal register 50 as the path control unit, and in response to a switching control signal LCON applied through a control line C1, the shared memory area 11 is operationally coupled to the first path unit 20 or second path unit 21.

As a result, when the first processor 100 coupled to the first port 60 accesses the shared memory area 11, lines L1, L110 and L121 adapted among the first path unit 20, switching unit 30 and shared memory area 11 are operationally coupled with one another.

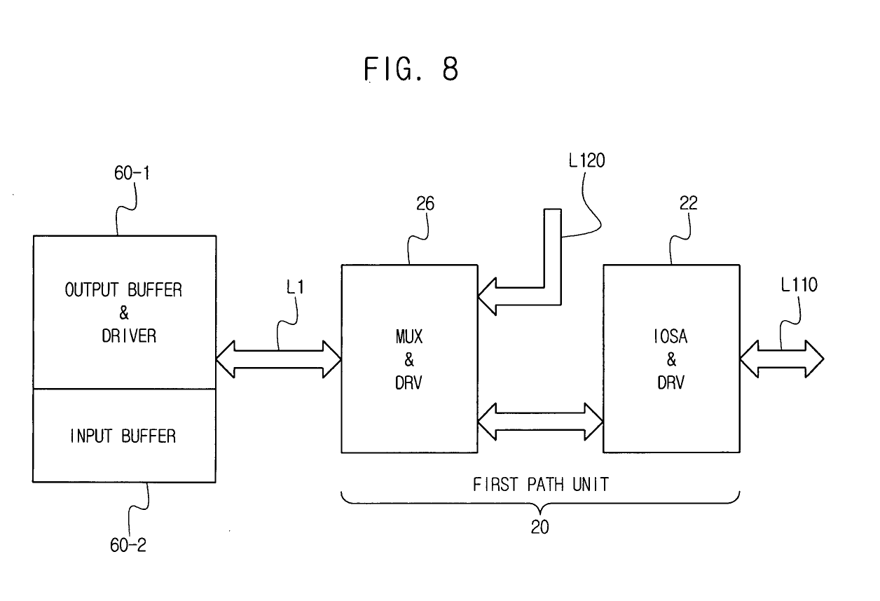

In FIG. 5, the first path unit 20 has a basic function of switching a line L1 to one of input/output lines L110 and L120, and may include an input/output sense amplifier and driver 22 and a multiplexer and driver 26, as shown in FIG. 8. Similarly, the second path unit 21 has a basic function of switching a line L2 to one of input/output lines L30, L111, and L31, and may include input/output sense amplifier and driver 22 and multiplexer and driver 26, as shown in FIG. 8.

An interrupt driver 170 may be coupled to the internal register 50 and used to apply a processor interrupt signal INTi to respective processors.

In an example embodiment, the first processor 100 may have a function of a MODEM processor performing a task, e.g., modulation and demodulation of a communication signal. The second processor 200 may have an application processor function performing a user convenience function such as a communication data processing or games or amusement etc.

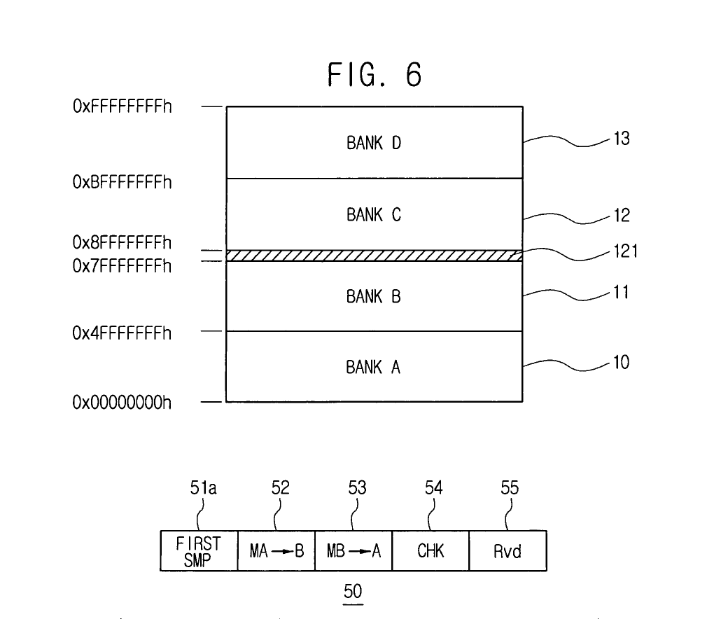

FIG. 6 provides an address assignment and substitutive access relation of internal register and memory banks referred to in FIG. 5.

In FIG. 6, assuming that respective banks 10-13 have a capacity of 16 megabits, a specific area of bank B, 11 as the shared memory area is determined as a disable area 121. For example, a specific row address (0x7FFFFFFFh˜0x8FFFFFFFh, 2 KB size=1 row size) enabling one optional row of the shared memory area 11 is assigned to the internal register 50 functioning as a path control and interface unit. The internal register 50 may include a semaphore area 51a, mailbox areas 52 and 53, a check bit area 54, and a reserve area 55. Then, when the specific row address (0x7FFFFFFFh˜0x8FFFFFFFh) is applied, a corresponding specific word line area 121 of the shared memory area 11 is disabled, but the internal register 50 is enabled. As a result, in an aspect of the system, the semaphore area 51 a, the mailbox areas 52 and 53, the check bit area 54, and the reserve area 55 are accessed by using a direct address mapping method, and in an internal aspect, a command approaching to a corresponding disabled address is decoded, thus performing a mapping to an internal register arranged outside the memory cell array. Thus, a memory controller of chip set driven by processors produces a command for this area in the same method as other memory cells.

In FIG. 6, access authority information for the shared memory area 11 is stored in first semaphore area 51a of the internal register 50. A message, e.g., authority request, address, data size, transmission data indicating an address of shared memory having storage data, or commands, etc., transmitted to mutual corresponding processors from the first and second processors 100 and 200, is written to mailbox areas 52 and 53. For example, a message transmitted from the first processor 100 to the second processor 200 is written to the mailbox area 52, and a message transmitted from the second processor 200 to the first processor 100 is written to the mailbox area 53.

The semaphore area 51a and mailbox areas 52 and 53 may be each assigned with 16 bits, and the check bit area 54 may be assigned with 4 bits. The reserve area 55 may be assigned with 2 bits as a preliminary area.

The areas 51a, 52, 53, 54 and 55 may be enabled in common by the specific row address, and may be individually accessed depending on an applied column address.

Consequently, the internal register 50 is a data storage area adapted specifically from the memory cell array area, for an interface between the first and second processors 100 and 200. The internal register 50 is accessed by both of the first and second processors, and may include a flip-flop and a data latch. For example, the internal register 50 includes a latch type storage cell different from a memory cell of the DRAM, and thus does not require a refresh operation.

For example, when a data interface between the first and second processors 100 and 200 is obtained through the first DRAM 400, the first and second processors 100 and 200 may write a message to be transmitted to a corresponding processor by using the mailboxes 52 and 53. A processor of a receiving party having read the written message recognizes the message of the transmission-party processor and performs its corresponding operation.

For example, when the second processor 200 of FIG. 3 transfers an access authority for the bank B, 11 as the shared memory area of the first DRAM 400 to the first processor 100, the second processor 200 changes a first flag data ‘1’ of the semaphore area 51a shown in FIG. 6 to ‘0’, and then writes a message to inform that the access authority is changed, to the mailbox 52. Then, after a lapse of given time, a second flag data of the semaphore area 51a is automatically changed from ‘0’ to ‘1’. Accordingly, the access authority for the shared memory area 11 is transferred to the first processor 100. The first processor 100 having read the message about the transfer of access authority from the mailbox 52, confirms as to whether the second flag data of the semaphore area 51a has been changed to ‘1’. After confirming the change of the second flag data to ‘1’, the first processor 100 writes a response message informing of a receipt of the access authority to the mailbox 53. Then, the first processor 100 exclusively has the access authority for the shared memory area 11 until an authority request of the second processor 200 is given or the task of the first processor itself 100 is completed.

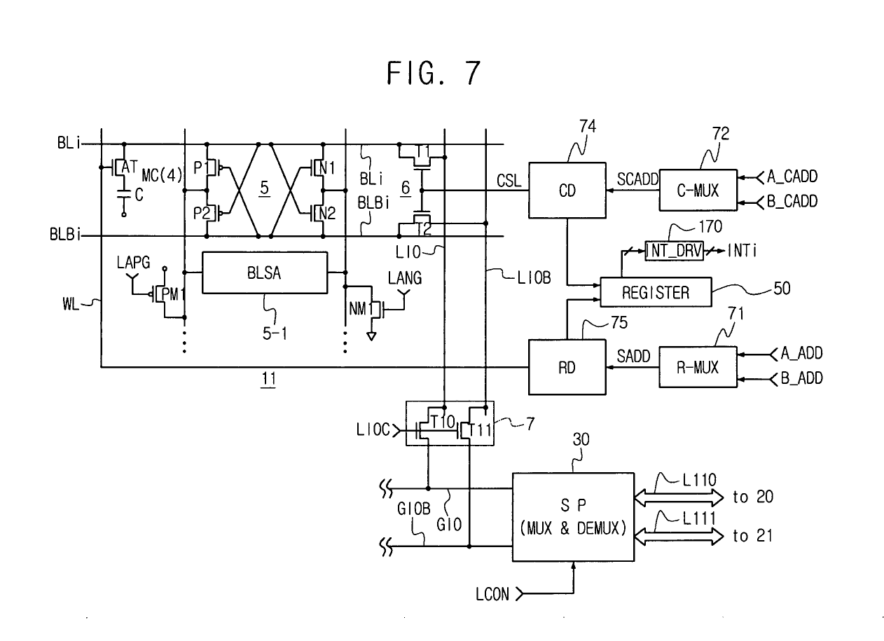

FIG. 7 is a circuit diagram illustrating in more detail an example of multipath accessing to the shared-memory area shown in FIG. 5. FIG. 8 is a block diagram illustrating a coupling example between a first port unit and a first path unit of FIG. 5, including an input/output sense amplifier and driver 22 and a multiplexer and driver 26.

Referring to FIG. 7, a DRAM cell MC 4 is the memory cell belonging to the shared memory area 11. In the drawing, the shared memory area 11 is shown being operationally coupled to one of the first and second path units 20 and 21 referred to in FIG. 5 through a switching operation of switching unit 30.

In the shared memory area 11, the DRAM cell 4 includes one access transistor AT and a storage capacitor C constituting a unit memory device. The DRAM cell 4 is coupled with intersections of a plurality of word lines WL and a plurality of bit lines BL, thus constituting a bank array of a matrix type. A word line WL shown in FIG. 7 is disposed between a gate of access transistor AT of the DRAM cell 4 and a row decoder 75. The row decoder 75 applies a row-decoded signal to the word line and the register unit 50 in response to a selection row address SADD of a row address multiplexer 71. A bit line BLi constituting a bit line pair is coupled to a drain of the access transistor AT and a column selection transistor T1. A complementary bit line BLBi is coupled to a column selection transistor T2. PMOS transistors P1 and P2 and NMOS transistors N1 and N2 coupled to the bit line pair BLi, BLBi constitute a bit line sense amplifier 5. Sense amplifier driving transistors PM1 and NM1 drive the bit line sense amplifier 5 by respectively receiving drive signals LAPG and LANG. A column selection gate 6 includes column selection transistors T1 and T2 coupled to a column selection line CSL transferring a column decoded signal of a column decoder 74. The column decoder 74 applies a column decoded-signal to the column selection line CSL and the register unit 50 in response to a selection column address SCADD of a column address multiplexer 72.

In FIG. 7, a local input/output line pair LIO, LIOB is coupled to a first multiplexer 7. When transistors T10 and T11 constituting the first multiplexer 7 are turned on in response to a local input/output line control signal LIOC, the local input/output line pair LIO, LIOB is coupled to a global input/output line pair GIO, GIOB. Then, data of the local input/output line pair LIO, LIOB is transferred to the global input/output line pair GIO, GIOB in a read operation mode of data. On the other hand, in a write operation mode of data, write data applied to the global input/output line pair GIO, GIOB is transferred to the local input/output line pair LIO, LIOB. The local input/output line control signal LIOC may be a signal generated in response to a decoded signal output from the row decoder 75.

Read data transferred to the global input/output line pair GIO, GIOB is transferred to a corresponding input/output sense amplifier and driver 22 through one of lines L110 and L111 as shown in FIGS. 7 and 8. Referring to FIG. 8, the input/output sense amplifier 22 serves as again amplifying data having a weak level in the transfer steps of several data paths. Read data output from the input/output sense amplifier 22 is transferred to first port 60 through multiplexer and driver 26 as shown in FIG. 8, the multiplexer and driver 26 and the input/output sense amplifier 22 constituting a first path unit 20. When the shared memory area 11 is accessed by the first processor 100, the second processor 200 is disconnected from the line L111. Thus, an access operation of the second processor 200 to the shared memory area 11 is intercepted. But, in this case, the second processor 200 can access the dedicated memory areas 12 and 13 through second port 61.

In a write operation, write data applied through the first port 60 is transferred to the global input/output line pair GIO, GIOB of FIG. 7 sequentially through an input buffer 60-2, multiplexer and driver 26, input/output sense amplifier and driver 22 and the switching unit 30 referred to in FIG. 8. When the first multiplexer 7 is activated, the write data is transferred to local input/output line pair LIO, LIOB and stored in a selected memory cell 4.

An output buffer and driver 60-1 and input buffer 60-2 shown in FIG. 8 may correspond to or be included in the first port 60 of FIG. 5. The input/output sense amplifier and driver 22 and the multiplexer and driver 26 may correspond to or be included in first path unit 20 of FIG. 5. The multiplexer and driver 26 prevents one processor from simultaneously accessing the shared memory area 11 or dedicated memory area 10.

As described above, the first and second processors 100 and 200 can access in common the shared memory area 11 in the semiconductor memory devices 400 and 500 according to an example embodiment of the invention with a detailed configuration such as shown in FIG. 7. Accordingly, the booting of first and second processors 100 and 200 can be attained even in a flashless structure. In addition, the first and second processors 100 and 200 can perform a data communication through the commonly accessible shared memory area 11 by utilizing the internal register 50 functioning as a path control and interface unit.

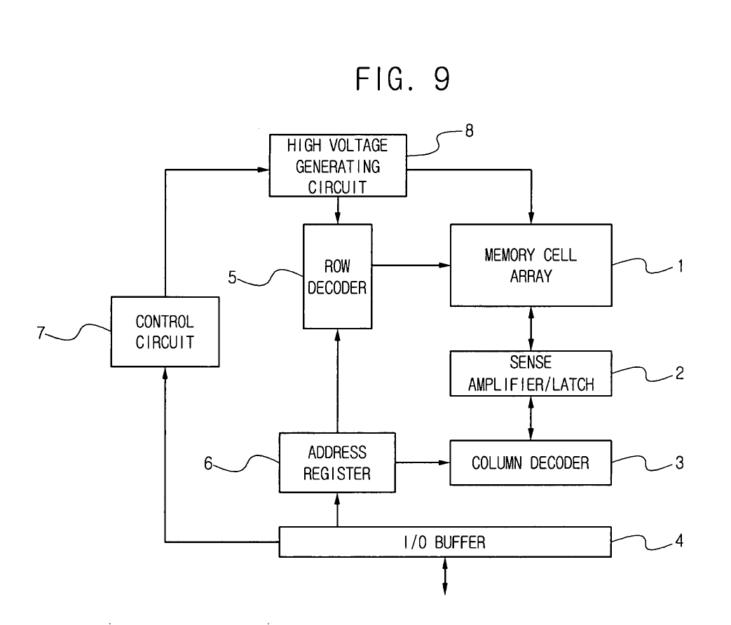

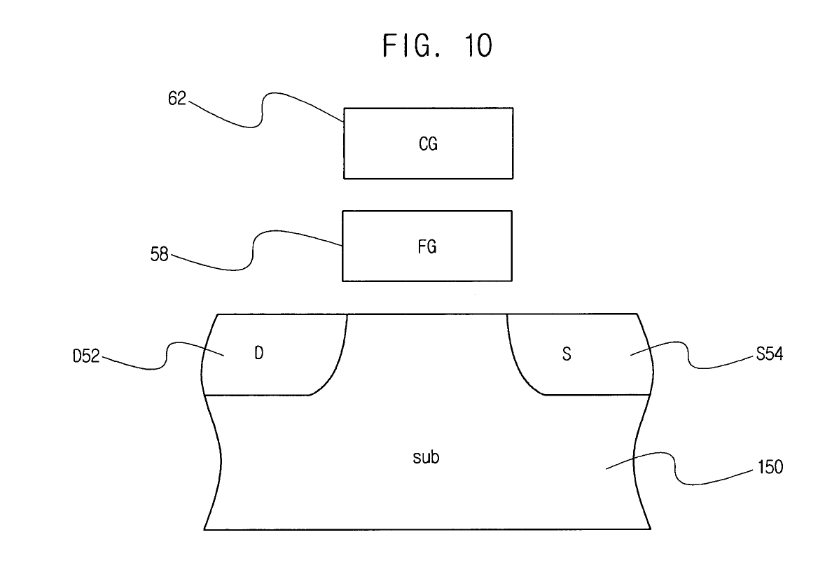

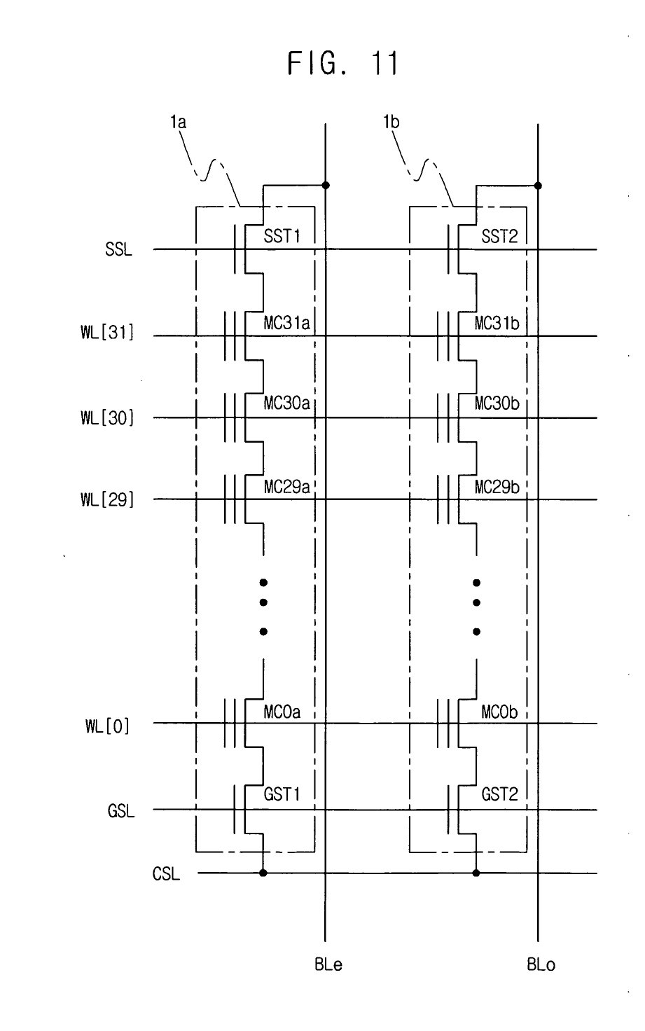

FIG. 9 is a block diagram of a nonvolatile semiconductor memory device of FIG. 3. FIG. 10 illustrates a structure of unit memory cells constituting a memory cell array of FIG. 9. FIG. 11 provides an example of a NAND-type memory cell array formed by disposing the unit memory cells of FIG. 10 in a string type.

Device blocks shown in FIG. 9 may be provided as a circuit block of a general nonvolatile semiconductor memory device, e.g. flash memory 300.

In FIG. 9 there are a block connection structure of NAND type flash EEPROM including a memory cell array 1, sense amplifier and latch 2, column decoder 3, input/output buffer 4, row decoder 5, address register 6, high voltage generating circuit 8 and control circuit 7. The sense amplifier and latch 2 may sense and store input/output data of memory cell transistors, and the column decoder 3 may select bit lines, and the row decoder 5 may select word lines. The address register 6 may store addresses, and the high voltage generating circuit 8 may generate high voltage higher than operation power voltage for a program or erase operation. The control circuit 7 may overall control an operation of nonvolatile semiconductor memory. A flash memory device having a structure similar to that in FIG. 9 corresponds to at least one of the nonvolatile memory areas 310 and 320 shown in FIG. 4. Respective chips are enabled by a specific chip enable pin, and have a structure coupled through a shared bus.

The memory cell array 1 may be configured in a NAND type as shown in FIG. 11. For example, FIG. 11 is an equivalent circuit diagram illustrating a connection structure in memory cells of the memory cell array 1. The memory cell array 1 includes a plurality of cell strings (NAND cell units), for example, a first cell string 1a coupled to an even bit line BLe and a second cell string 1b coupled to an odd bit line BLo are shown in FIG. 11.

The first cell string 1a includes a string selection transistor SST1 having a drain coupled to the bit line BLe, a ground selection transistor GST1 having a source coupled to a common source line CSL, and a plurality of memory cell transistors MC31a, MC30a, . . . , MC0a having drain-source channels coupled in series between a source of the string selection transistor SST1 and a drain of the ground selection transistor GST1. Similarly, the second cell string 1b includes a string selection transistor SST2 having a drain coupled to the bit line BLo, a ground selection transistor GST2 having a source coupled to the common source line CSL, and a plurality of memory cell transistors MC31b, MC30b, . . . , MC0b having drain-source channels coupled in series between a source of the string selection transistor SST2 and a drain of the ground selection transistor GST2.

A signal applied to a string selection line SSL is supplied in common to gates of the string selection transistors SST1 and SST2, and a signal applied to a ground selection line GSL is supplied in common to gates of the ground selection transistors GST1 and GST2. Word lines WL0-WL31 are coupled equivalently in common to control gates of memory cell transistors belonging to the same row. The bit lines BLe and BLo operationally coupled to the sense amplifier and latch 2 of FIG. 9 are disposed crossing the word lines WL0-WL31 on different layers, and the bit lines BLe and BLo are disposed in parallel with each other on the same layer.

An optional memory cell transistor shown in FIG. 11 includes a MOS transistor having a floating gate 58 below a control gate 62, as shown in FIG. 10.

Operations of a unit memory cell including the MOS transistor having a charge-storage floating gate will now be described in brief with reference to FIG. 10.

In operations of a NAND-type EEPROM, erase, write and read operations are described as follows. The erase and program (write) operation can be obtained by using an F-N tunneling current. For example, in the erase operation, a very high potential is applied to a substrate 150 shown in FIG. 10 and a low potential is applied to the CG (Control Gate) 62 of memory cell transistor. In this case, potential decided by a coupling ratio for a capacitance between CG and a floating gate (FG) 56 and a capacitance between the FG 58 and the substrate 150 is applied to the FG 58. When a potential difference between a floating gate voltage Vfg applied to the FG 58 and a substrate voltage Vsub applied to the substrate 150 is greater than a potential difference creating an F-N tunneling, electrons gathered in the FG 58 move from the FG 58 to the substrate 150. Such operation lowers a threshold voltage Vt of a memory cell transistor including CG 62, FG 58, a source S54 and a drain D52. Since the Vt is sufficiently lowered in the erase operation, when 0 V is applied to the CG 62 and the source S54 and an appropriately high level of voltage is applied to the drain D52, current flows. Accordingly, the memory cell may be called “ERASED”, which may be logically represented as ‘1’.

Meanwhile, in the write (program) operation, 0V is applied to the source S54 and the drain D52 and a relatively very high voltage is applied to the CG 62. At this time, an inversion layer is formed in a channel region and the source and drain both have a potential of 0V. When a potential difference applied to between Vchannel (0 V) and Vfg decided by a rate of the capacitance between CG and FG and the capacitance between FG and the channel region, becomes great enough to create the F-N tunneling; electrons move from the channel region to the FG 58. Since Vt increases in the write (program) operation, when a predetermined positive voltage is applied to the CG 62, 0V is applied to the source S54, and an appropriate level of voltage is applied to the drain D52, current does not flow. Accordingly, the memory cell may be called “PROGRAMMED”, which may be indicated as a logic ‘0’.

In a memory cell array having a plurality of cell strings such as the first and second cell strings, a unit of page indicates memory cell transistors for which control gates are coupled in common to the same word line. A plurality of pages including a plurality of memory cell transistors are provided as a cell block, and one cell block unit generally includes one or plurality of cell strings per bit line. A NAND flash memory has a page program mode for a high-speed programming. A page program operation is classified as a data loading operation and a program operation. The data loading operation sequentially latches and stores data of a byte magnitude in data registers from input/output terminals. The data registers are adapted corresponding to respective bit lines. The program operation writes at one time data stored in the data registers, to memory transistors on a word line selected through the bit lines.

In the NAND-type EEPROM described above, read operation and program operation are generally performed by a unit of page, and the erase operation is performed by a unit of block. Generally, a movement of electrons between a channel and an FG of the memory cell transistor is performed just in program and erase operations, and in read operation, an operation of just reading intact data stored in memory cell transistor without damaging the data is performed after the erase and program operation are completed.

In the read operation, a voltage (generally, read voltage) higher than a selection read voltage Vr applied to CG of a selected memory cell transistor is applied to a CG of non-selected memory cell transistor. Then, current flows or does not flow through a corresponding bit line according to a program state of the selected memory cell transistor. When a threshold voltage of a memory cell programmed under a predetermined voltage condition is higher than a reference value, the memory cell is decided as an off-cell, thus charging a corresponding bit line to voltage of a high level. To the contrary, when a threshold voltage of programmed memory cell is lower than the reference value, the memory cell is decided as an on-cell, and a corresponding bit line is discharged to a low level. This state of the bit line is finally read out as ‘0’ or ‘1’ through a sense amplifier 2 called the page buffer.

Memory cell transistors of the cell string initially have an erase operation to have a threshold voltage of, e.g., approximately −3V or below. Then, when programming a memory cell transistor, a high voltage is applied to a word line corresponding to a selected memory cell for a given time, and the selected memory cell is changed into a relatively higher threshold voltage. Meanwhile, threshold voltages of memory cells not selected in programming are not changed.

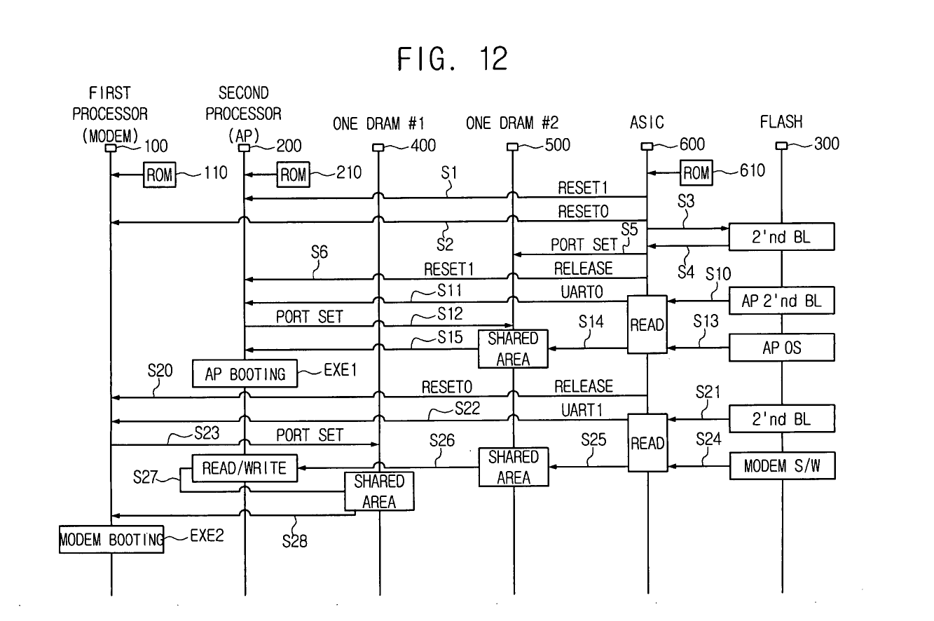

FIG. 12 illustrates a control flow of booting in a multiprocessor system according to an example embodiment of the invention.

An operation according to an example embodiment of the invention is described as follows, on the basis of FIG. 12 and referring to the accompanying drawings.

Referring to FIG. 12, when the power source is applied to multiprocessor system referred to in FIG. 3, the first, second and third processors 100, 200 and 600 read a first boot loader from their own respective ROM memories 110, 210 and 610. The first boot loader is a program for an initialization of the respective processors, and may be a program, e.g., a master boot recorder (MBR) etc. For example, the first, second and third processors 100, 200 and 600 read the first boot loader writable in an assembly language and perform an initialization at a low level necessary for an operation of the respective processors. By such an initialization execution, a register of the memory controller adapted inside the respective processors is set, the speed of system clock is determined, and a UART is also initialized.

In the steps S1 and S2 of FIG. 12, the third processor 600 applies reset signals RESET0 and RESET1 to the first and second processors 100 and 200 through the line L10 to prevent a booting time out of the first and second processors 100 and 200. Accordingly, in FIG. 3, the first processor 100 is reset by the reset signal RESET0 applied to a reset terminal R1 through the reset line L12. The second processor 200 is reset by the reset signal RESET1 applied to a reset terminal R2 through the reset line L11.

The third processor 600 accesses an area 321 of the flash memory 300 of FIG. 4 in a step S3, and reads the second boot loader stored in the area 321 at a step S4, and then sets a port of the second DRAM 500 in a step S5. The second boot loader is a program to operate an operating system of the respective processors, and may be a program, e.g., NTLDR (NT Loader) or GRUB (Grand Unified Boot loader) etc. The program may be written in a C language, and be used for performing an initialization at a relatively high level on the basis of the initialization environment of the low level. The step S4 provides an operation of reading data stored in the floating gate 58 of FIG. 10, where details for the read operation have been already described above through FIGS. 9 to 11. In the step S5, the second DRAM 500 is controlled such that the third processor 600 has an access authority to the shared memory area 11 shown in FIG. 5. The authorization of access for the shared memory area I1 has been already described above with reference to FIGS. 5 to 8.

In a step S6, the third processor 600 releases a reset of the second processor 200, and then reads the second boot loader of the second processor 200 stored in an area 331 of the flash memory 300 in a step 51. In a step S11, the third processor 600 transmits the second boot loader read in the step S10, to the second processor 200 sequentially through UART/SP1 lines L20 and L21 of FIG. 3. The second processor 200 performs a port setting operation on the second DRAM 500 in a step 512. In a step 513, the third processor 600 reads software, e.g., OS, of the second processor 200, stored in an area 333 of the flash memory 300, and writes the read software to the shared memory area 11 of the second DRAM 500 in a step 514. Then, the second processor 200 executes (EXE1) its own booting operation by reading the OS written to the second DRAM 500 in a step S15. At this time, in the reading of the OS in the step S15, the second processor 200 has the access authority for the shared memory area 11. For example, the transfer of access authority is attained by utilizing the internal register 50 having the semaphore and mailbox. The booting for the second processor 200 is completed through the operations to the step 515.

When the booting for the second processor 200 is completed, the third processor 600 releases a reset of the first processor 100 in a step S20. Then, the first processor 100 of FIG. 3 is reset by a reset release signal RESET0 applied to the reset terminal R1 through the reset line L12. The third processor 600 reads the second boot loader of the first processor in a step S21, and transmits the second boot loader to the UART/SP1 L22 in a step S22. Accordingly, the first processor 100 receives the transmitted second boot loader through a serial port, then sets a port of the first DRAM 400 in a step S23.

In a step S24, the third processor 600 reads software, e.g., MODEM software, of the first processor 100 stored in the area 313 of the flash memory 300, then writes the read software to the shared memory area 11 of the memory link architecture 700 in a step S25. Thus, the second processor reads the software written to the second DRAM 500 in a step S26, then writes the read software to the shared memory area of the first DRAM 400 in a step S27. Subsequently, the first processor 100 reads the software written to the bank B11 as the shared memory area of the first DRAM 400 in a step S28, thereby executing (EXE2) its own booting operation. As a result, the booting operation of the first processor 100 is completed. The access authority request or change for the shared memory area 11 of the first and second DRAMs 400 and 500 has been already described with reference to FIG. 6. Through the steps of operations described above, the system booting operation for the first ands second processors 100 and 200 in the multiprocessor system with a flashless structure is completed.

According to example embodiments of the invention described above, a booting of processors may be more smoothly performed even in a flashless structure where booting flash memories are not directly coupled to the processors. Thus, flash memories employed for a booting of processors are not adapted in the systems, and therefore implementation expenses of systems are reduced and the size of the system becomes more compact. As described above, a multiport semiconductor memory device and a high-performance multiprocessor system based on the memory link architecture can be obtained that performs a booting in the flashless structure.

In a multiprocessor system according to an example embodiment of the invention, the number of processors may increase to three or more. In the multiprocessor system, the processor may be a microprocessor, CPU, digital signal processor, micro controller, reduced-command set computer, complex command set computer, or the like. Meanwhile, it is noted herein that the scope of the invention is not limited to the number of processors in the system. Nor is the scope of the invention limited to any special combination of processors in adapting the same or different processors as the example embodiments described above.

It will be apparent to those skilled in the art that modifications and variations can be made in the present invention without deviating from the spirit or scope of the invention. Thus, it is intended that example embodiments of the invention cover any such modifications and variations of this invention provided they come within the scope of the appended claims and their equivalents.

For example, in other cases, the structure of the memory link architecture or the booting sequence, the structure of shared memory bank of a multiport semiconductor memory, the structure of the semaphore and mailbox in the internal register, or the structure of the circuit and the access method may be changed or varied, without deviating from the spirit of example embodiments of the invention.

Furthermore, although the system booting is performed principally by an ASIC processor, the system booting may be performed by other processors, and in addition, an implementation of a data path controller to control a data path between the port units and the shared memory area of the DRAM may be obtained in various kinds of methods. Although the structure of semaphore using an internal register is described above as the example, the technology of example embodiment of the invention may be applied extendedly to other nonvolatile memories, such as PRAM etc., without limiting to the above-description.

Accordingly, these and other changes and modifications are seen to be within the true spirit and scope of the invention as defined by the appended claims.

In the drawings and specification, there have been disclosed example embodiments of the invention and, although specific terms are employed, they are used in a generic and descriptive sense only and not for purposes of limitation, the scope of the invention being set forth in the following claims.

What is claimed is:

1. A multiprocessor system comprising:
first and second multiport semiconductor memory devices;
first, second and third processors individually storing a first boot loader, the first and second processors being configured to access the first multiport semiconductor memory device, and the second and third processors being configured to access the second multiport semiconductor memory device; and
a memory link architecture including the second multiport semiconductor memory device, the third processor, and a nonvolatile semiconductor memory device,
the nonvolatile semiconductor memory device including a plurality of storage areas storing a second boot loader and software for the first, second and third processors, and
the third processor being configured to access the nonvolatile semiconductor memory device and configured to apply the second boot loader to the first and second processors through a serial communication to perform a portion of booting the system.

2. The system of claim 1, wherein the third processor reads the software for the second processor and then provides the software for the second processor to the second processor through the second multiport semiconductor memory device.

3. The system of claim 2, wherein the second multiport semiconductor memory device and the first multiport semiconductor memory device sequentially provide the software for the first processor to the first processor.

4. The system of claim 3, wherein the software for the first processor is modem software, and the software for the second processor is software of an operating system.

5. The system of claim 2, wherein the third processor reads the software for the first processor and then provides the software for the first processor to the second processor through the second multiport semiconductor memory device, the second processor writes the software for the first processor to the first multiport semiconductor memory device, and the first multiport semiconductor memory device provides the software for the first processor to the first processor.

6. The system of claim 1, wherein the first, second and third processors include a read only memory (ROM), the first boot loader being a program for an initialization of the first, second and third processors that is stored in the ROM of the first, second and third processors.

7. The system of claim 6, wherein the second boot loader is a program to operate an operating system of the first, second and third processors.

8. A multiprocessor system comprising:
a first multiport semiconductor memory device including a shared memory area assigned in a memory cell array and an internal register positioned outside the memory cell array, the internal register adapted to provide an access authority for the shared memory area;
first and second processors individually having a storage memory and a reset terminal, the storage memory being configured to store a first boot loader, with the first and second processors configured to receive the access authority for the shared memory area through the internal register and configured to access in common the shared memory area through different ports of the first multiport semiconductor memory device; and
a memory link architecture block including a third processor having a first boot loader storage memory, a second multiport semiconductor memory device, and a nonvolatile semiconductor memory device,
the second multiport semiconductor memory device including a shared memory area assigned in a memory cell array and an internal register positioned outside the memory cell array, the second and third processors configured to access the shared memory area in common through different ports of the second multiport semiconductor memory device, and the internal register adapted to provide an access authority for the shared memory area to the second and third processors,
the nonvolatile semiconductor memory device having a plurality of areas storing a second boot loader and software for the first, second and third processors, and
the third processor configured to access the nonvolatile semiconductor memory device and configured to provide the second boot loader of the first and second processors stored in the nonvolatile semiconductor memory device to the first and second processors through a serial communication port in booting the system.

9. The system of claim 8, wherein the first boot loader is a program for an initialization of at least one of the first, second and third processors, and the second boot loader is a program to operate an operating system of at least one of the first, second and third processors.

10. The system of claim 9, wherein the third processor reads the software for the second processor and then provides the software for the second processor to the second processor through the second multiport semiconductor memory device, and wherein the second multiport semiconductor memory device and the first multiport semiconductor memory device sequentially provide the software for the first processor to the first processor.

11. The system of claim 10, wherein the third processor reads the software for the first processor and then provides the software for the first processor to the second processor through the second multiport semiconductor memory device, the second processor writes the software for the first processor to the first multiport semiconductor memory device, and the first multiport semiconductor memory device provides the software for the first processor to the first processor.

12. The system of claim 8, wherein the third processor applies a reset signal to the reset terminal of the first and second processors to prevent a booting time out of the first and second processors.

13. A memory link architecture block comprising:
a first multiport semiconductor memory device including a shared memory area assigned in a memory cell array and a first port;
a first processor storing a first boot loader for the first processor, the first processor configured to access the shared memory area through the first port of the first multiport semiconductor memory device; and
a nonvolatile semiconductor memory device having a plurality of areas storing a second boot loader and software for at least the first processor, the first processor being configured to access the nonvolatile semiconductor memory device.

14. A multiprocessor system comprising:
the memory link architecture block of claim 13;
a second multiport semiconductor memory device; and
second and third processors storing first boot loaders for the second and third processors, respectively, the second and third processors being configured to access the second multiport semiconductor memory device, and the second processor being further configured to access the shared memory area of the first multiport semiconductor memory through a second port of the first multiport semiconductor memory device, wherein
the nonvolatile semiconductor memory device further stores second boot loaders and software for the second and third processors, and
the first processor applies the second boot loader to the first and second processors through a serial communication to perform a portion of booting the system.

15. The system of claim 14, wherein the first multiport semiconductor memory device further includes an internal register positioned outside the memory cell array, the internal register adapted to provide an access authority for the shared memory area to the first and second processors.

16. The system of claim 14, wherein the second multiport semiconductor memory device includes a shared memory area assigned in a memory cell array and an internal register positioned outside the memory cell array, the second and third processors configured to access the shared memory area in common through different ports of the second multiport semiconductor memory device, and the internal register adapted to provide an access authority for the shared memory area of the second and third processors.

17. The system of claim 14, wherein the first multiport semiconductor memory device and the second multiport semiconductor memory device sequentially provide the software for the first processor to the first processor.

18. The system of claim 17, wherein the first processor reads the software for the third processor and then provides the software for the third processor to the second processor through the first multiport semiconductor memory device, the second processor writes the software for the third processor to the second multiport semiconductor memory device, and the second multiport semiconductor memory device provides the software for the third processor to the third processor.

19. The system of claim 14, wherein the first, second and third processors include a read only memory (ROM), the first boot loader being a program for an initialization of the first, second and third processors that is stored in the ROM of the first, second and third processors, and the second boot loader being a program to operate an operating system of the first, second and third processors.

20. The system of claim 14, wherein the software for the third processor is modem software, and the software for the second processor is software of an operating system.
